(19) United States
(12) Patent Application Publication
(10) Pub. No.: US 2004/0257301 A1
(43) Pub. Date: Dec. 23, 2004

(54) Method for projecting signs on printed matter and means for the same

(76) Inventor: Amichai Ben Ari, Neve Daniel (IL)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/749,568

(22) Filed: Jan. 2, 2004

(30) Foreign Application Priority Data
Jan. 2, 2003 (IL) 153783

(51) Int. Cl. G09G 3/00

(52) U.S. Cl. 345/30

(57) ABSTRACT

The invention provides a method and means for projecting signs onto printed matter, without physically changing the printed matter. The method is especially useful for projecting signs on holy scripts such as the Torah, for aid of its reading.

### FIELD OF THE INVENTION

The present invention generally relates to a method for aiding the reading of printed matter.

### BACKGROUND OF THE INVENTION

The Jewish torah scroll is written in biblical Hebrew. For thousands of years, the bible has been copied by experts, without changing anything in the text or in its appearance, e.g., keeping the stiff roles of the fonts size and type etc. The bible text is read three times a weeks, and on holidays. This ancient text is hard to read to those that are not skilled in the art, known by the Hebrew term baaley qria. Various symbols were added over the years to didactic biblical texts, some of them are the cantillation marks which are diacritic symbols annotating the text for the purpose of cantillation. Those marks are also known in Hebrew by the term ‘ta’amey hamiqra’ and used to indicate how a text is to be chanted or sung. The cantillation marks are adapted to have interpretative means how to read the word, how to understand the sentence, how to sing or chant the phrase and to provide an absolute unity in reading the bible text, so that non-traditional reading of the text is unaccepted. The biblical text is also poor in vowel and punctuation marks, thus requiring an acknowledged amount of experience in the text in order to read it and to understand it properly Because no writing is allowed on the holly scroll, every student reading the text today is obligated to memorized the chant of reading the text by heart, by repeating along with either his Rabbi or by repeating a recording of a baaley qria numerous times.

As the years pass, less and less people are trained and skilled in the art of reading the torah in the traditional orthodox manner. Thus, only few such baaley qria are available to serve the community. Additionally, the daily time-table of the modem life does not provide sufficient time for those who know to read the bible text, to prepare the reading, so the quality, unity and thus the current availability of said reading is significantly reduced. A simple, convenient and reliable way for reading the torah, especially in a manner acceptable by Jewish orthodox Rabbis, is thus strongly desired.

### SUMMARY OF THE INVENTION

It is thus the main goal of the present invention to provide a useful method for projecting signs on top of a printed matter in order to help the reading of said printed matter without altering the original text. Said method comprising the steps of providing said printed matter in a manner suitable for said projection. Then, said signs are prepared on a suitable media in the manner so that said signs are in alignment with said printed matter. Lastly, said signs are projected on top of said printed matter such that said signs are superimposed on the printed matter in a predetermined manner.

The first step of the method of the invention is the provision of the printed matter in a suitable form for projection. Typically the printed matter should be correctly aligned with the suitable media comprising the signs to be projected on top of the printed matter.

The media should be such that it can be projected on the printed matter in a manner that the signs are superimposed on the printed matter in a correct orientation, so one reading the printed matter views the superimposed signs incorporated with the printed matter as one integral, easily read text.

By one option, the signs are present on a transparent sheet that is physically placed on the printed matter, in accordance with suitable alignment positioning clues so that the signs are read with the text on which they are superimposed.

By another option, the suitable media is a visual -projection of characters carried out with the aid of a suitable projector wherein the page on which the text is printed, serves as the screen. The projector may be connected to a slide projector, a computer or any other suitable device capable of transmitting the signs.

It is in the scope of the present invention wherein the printed matter is a traditional torah scroll written by hand and further wherein the projected signs are cantillation marks. Moreover, those signs are preferably selected from cantillation marks (i.e., in Hebrew: Teamey Mikra), vowel marks, punctuation marks, and/or musical notes. It is also in the scope of the present invention wherein the said signs are means for editing the printed matter to be more readable. Similarly, those signs are preferably selected from page number, header and/or footer, symbols, graphical signs, references and links, proofreading signs, the last word of previous page, the first word of coming page and/or the queue for reading the torah (i.e., in Hebrew: aliya latorah). Alternatively or additionally, aforementioned signs are selected from Braille notes, text printed in various languages, colors, sizes and fonts, pictures and/or drawn animations. It is acknowledged that a plurality of insertion layers is to be projected or superimposed on top of the printed manner.

It is also in the scope of the present invention to provide a useful method, especially adapted for computerized projecting of signs on top of printed matter. The aim of the method is to prepare a set of signs for projection on a printed matter, such that each sign will be projected in appropriate position respective to a character, or respective to a group of characters of the printed mater. According to one preferred embodiment said method comprising the following seven steps: (i) scanning the printed matter such in a way the text is restored in a file. (ii) obtaining or creating a database comprising a list of sign to be incorporated into the said text. (iii) retrieving a character or a plurality of characters from the said text file. (iv) A sign or a plurality of signs is retrieved from the said database. (v) Said conjugated character-sign couple is compared with a reference character-sign couple. (vi) Said conjugated couple is fitted or not fitted in a loop such in the way that all the text is projected by the coordinated signs. Lastly, in step (vii) the enriched text is projected by the coordinated signs.

According to the present invention the method for computerized projection of signs may vary according to the actual printed matter and according with the actual signs that should be projected. For example, when dealing with a homogeneous text (namely a text comprising a set of characters each of which has predetermined dimensions and a predetermined shape in any of its repetitions along the text) the method could make use of the predetermined dimensions data for calculating the position of each sign to be projected, for obtaining the desired correlation between a character (or a group of characters) and a corresponding sign or a group of signs. When dealing with a non homogeneous text, such as a hand written text of the Torah wherein each character may vary in an extreme manner, either in its dimensions and in its shape, along its different repetitions in the text, the calculation of the appropriate positioning of the signs (in this case the Biblical cantillation marks) may not relay on general predetermined dimension and shape characteristics, but should be prepared as a tailor made, especially adapted to the text of the actual physical Torah scroll for which the media for projection is being prepared.

According to one preferred embodiment the determination and allocation of an appropriate position for each sign in the media to be projected, is made in real time, i.e. during the scanning of the text and upon optical character recognition (OCR) of the characters, wherein at the moment of recognition of a character its exact X-Y coordination on the scanned sheet is known to the computer means dealing with the scanning and the recognition, thus could be used for determining and allocating an appropriate respective position to a corresponding sign, on the media being prepared for projection.

According to another embodiment the positioning of the signs (e.g. cantillation marks) in the media being prepared for projection, is not made in real time, i.e. during the OCR. According to this embodiment, the computer stores the X-Y coordination of each of the scanned characters (and according to other variations of the method, of each word or group of characters), and a computer program calculates the position of the signs (or cantillation marks) and deals with preparing the media to be projected, after the completion of the scanning of the text. It is still in the scope of the present invention to present a transparent polymeric sheet member adapted to be placed in a superimposed manner on top of a printed matter in the method defined in any of the above so that the signs are aligned and incorporated properly with the printed text. Said sheet may be a composition of a plurality of stripes, projecting said signs mostly the line of the text and not the spaces between lines. According to one preferred embodiment of this invention, the transparent sheet could be printed with signs for projection, directly from a computer having appropriate program for preparing such media according to the method of computerized projection, and through a conventional laser printer. According to other preferred embodiments the signs are printed on the transparent sheet according to the computerized projection data, in any acceptable printing or photographing way.

Lastly, it is also an aim for the present invention to present a scrolling device useful for coordinate the projecting sheet member on the printed matter so signs are projected on top of the printed matter in alignment (coordinated) with the text. Said device preferably comprising a first roll and a second roll, wherein a long projecting sheet member is accommodate in between, and further wherein at least one of said rolls is having means to roll the sheet so each of the pages of the printed matter is fitting a known portion of the signs.

### BRIEF DESCRIPTION OF THE DRAWINGS

In order to understand the invention and to see how it may be carried out in practice, some preferred embodiments will now be described, by way of non-limiting examples only, with reference to the accompanying drawings, in which:

FIG. 1 presents a copy of a part of a Jewish torah scroll comprising no punctuation marks;

FIG. 2 presents a transparent sheet comprising cantillation marks coordinated with said torah text; and

FIG. 3 presents a projected view of the torah text comprising the cantillation marks;

FIG. 4 schematically presenting a scrolling device on first page, without projection of signs; and

FIG. 5 schematically presenting the said scrolling device on second page, after the projection of signs; and

FIG. 6A schematically presenting one transparent sheet accommodated in a frame and FIG. 6B schematically presenting an array of multiple transparent sheets accommodated in a pager.

FIG. 7 schematically presenting a block diagram of a program adapted to project cantillation marks on traditionally written bible texts.

### DETAILED DESCRIPTION OF THE INVENTION

The following description is provided, along all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide the method for projecting insertion on printed matter The present invention generally relates to a method for projecting signs on a printed matter. Said printed matter is generally selected from any book, handbook, textbook, reference book, encyclopedia, notebook and especially any pedagogic written media. In the core of the present invention, said printed matter is a traditional Jewish torah scroll (i.e., in Hebrew: Safer Torah), wherein the text of the bible is written by the hand of an expert (i.e., in Hebrew: Safer Stem).

In the following the term “projecting” is meant to encompass both projection of a visual signal in the form of a sign on a text, in a manner similar to projection of visual signs on a screen as well as to the physical superposition of a transparent film bearing the signs on the printed matter so that in appearance the signs are superimposed on the text.

More specifically, the present invention relates to a method to project signs such as cantillation, vowel and punctuation marks on an original text. Said text is usually written by hand, such as the traditional Jewish bible scrolls, musical notes etc., and therefore it is essential that the original is not altered by adding to the text anything else. In addition, those inserts are selected from various editing notes. Said notes are selected, yet not limited to a page number, references and links, proofreading, header and footer etc. More over, those insertion been projected on top of the text may be selected from Braille notes, symbols, graphical signs and/or pictures. In particularly, said inserts may be also selected from any musical notations, such as clefs, scales, notes, harmony and/or chord indications etc.

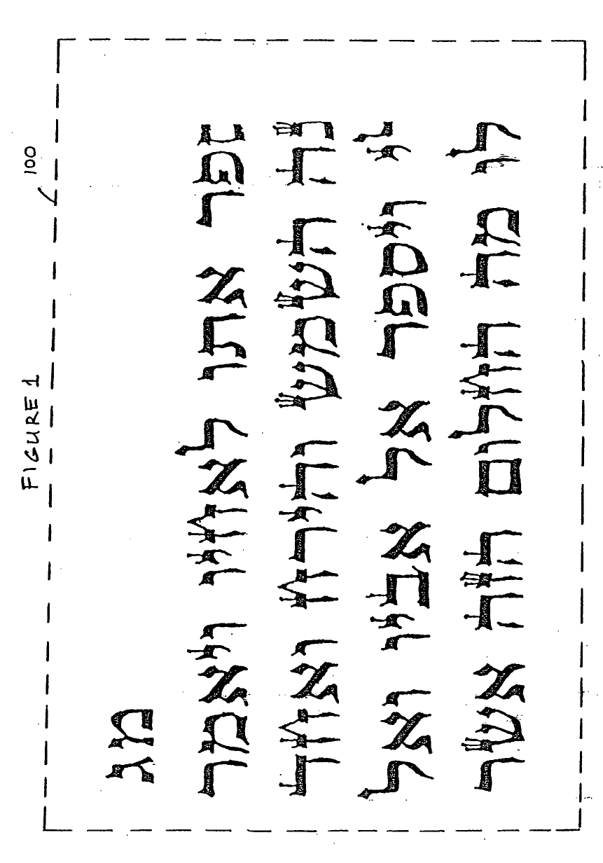

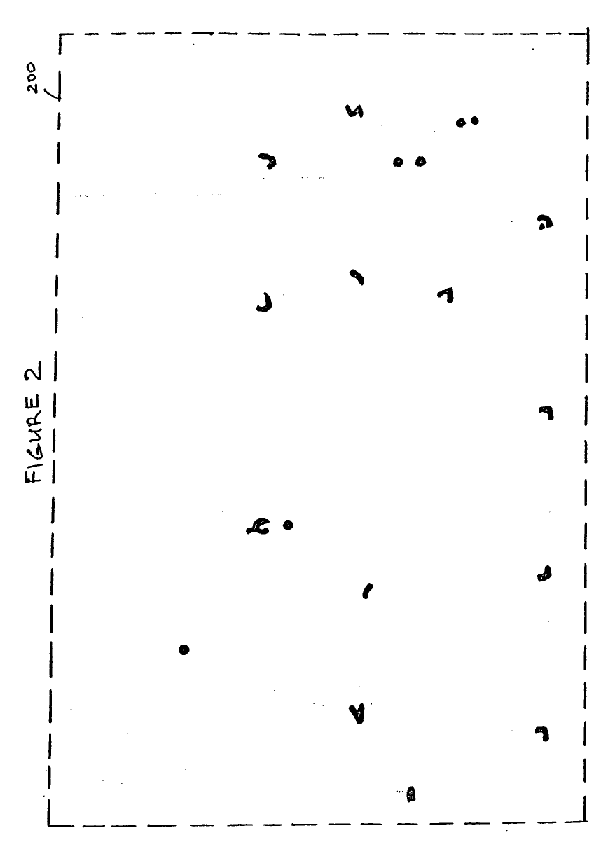

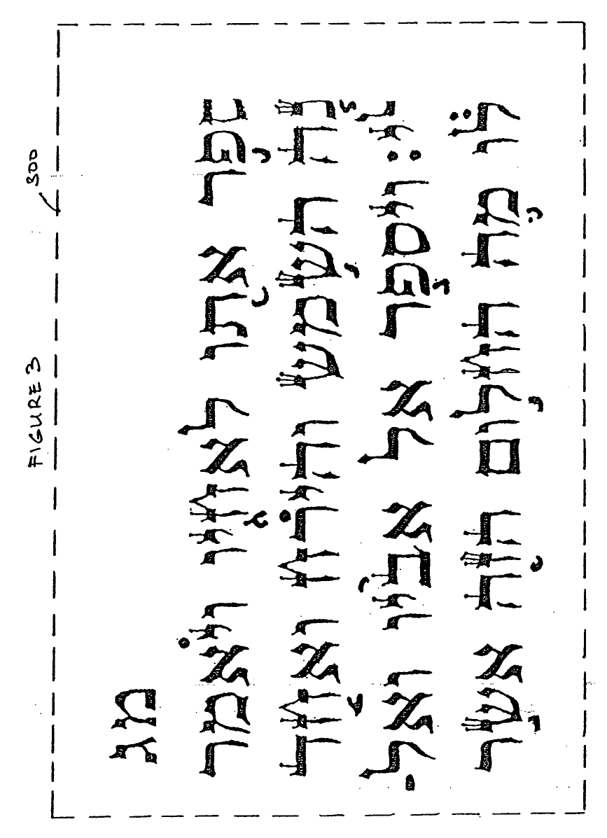

Reference is made now to FIG. 1, presenting a copy of a part of a Jewish torah scroll having neither punctuation, cantillation nor vowel marks. FIG. 2 presents a transparent sheet comprising cantillation marks coordinated with said torah text. FIG. 3 presents a projected view of the torah text comprising the cantillation marks.

As set forth, it is in the scope of the present invention to provide a useful method to project aforementioned inserts on top of a torah book. As one can see in FIGS. 1-3, each page of said scroll comprises 48 to 60 lines in a page and 35 to 55 characters in one line, a transparent sheet adapted for overhead projector is mostly suitable. A polyethylene terphthalate made sheet is suitable for this instance. For various instances, a laminated film as such as polyester is suitable. Alternatively, a strip of self-adherent polymer is to be used.

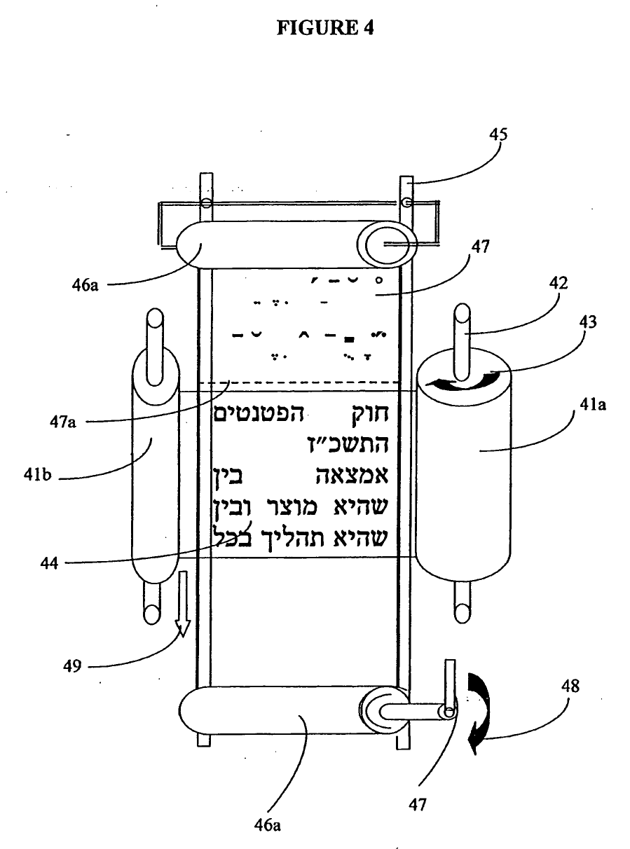

Said polymeric sheet may be adapted for a singular use or alternatively, said sheet may be adapted for a continuous use. Such a continuous use is provided by means of a fixed or mobile rolling device. The said roll is adapted to use an elongated polymeric sheet, accommodated in a suitable cartridge. Reference is thus made now to FIG. 4 schematically presenting a traditionally handmade bible scroll comprising a first roll (41a) and a second roll (41b). Said rolls are operated by means of set of handles (such as 42) in the direction (43). The biblical text (44) is delivered from the first roll to the second one.

A mobile rolling device as defined above is located adjacent to the said bible scroll. Said device comprises of a frame (45) located under the biblical text. A transparent long sheet (47) is delivered from a first roll (46a) towards a second roll (46b) be means of handle (47), rotated in a 360° movement in the direction (48) so the transparent sheet is moving downwards (49). To align the insertion printed on sheet (47) with the biblical text (44) is easily provided by means dashed line (47a) indicating the proper place of the sheet on top of the text.

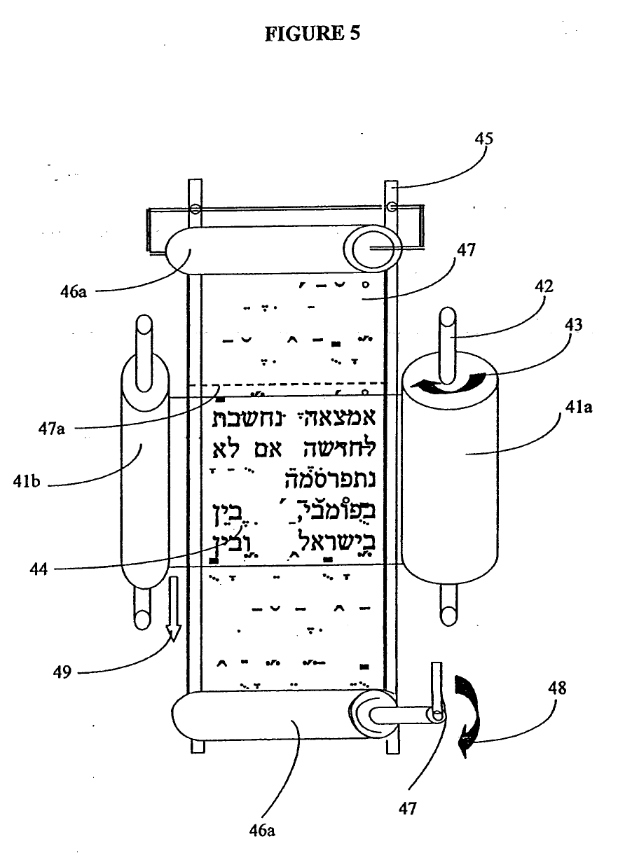

Subsequently, reference is made now to FIG. 5, presenting the very same roller, whereat the text was rolled to a certain page, and further wherein the cantillation marks are projected on top of the text of the said page.

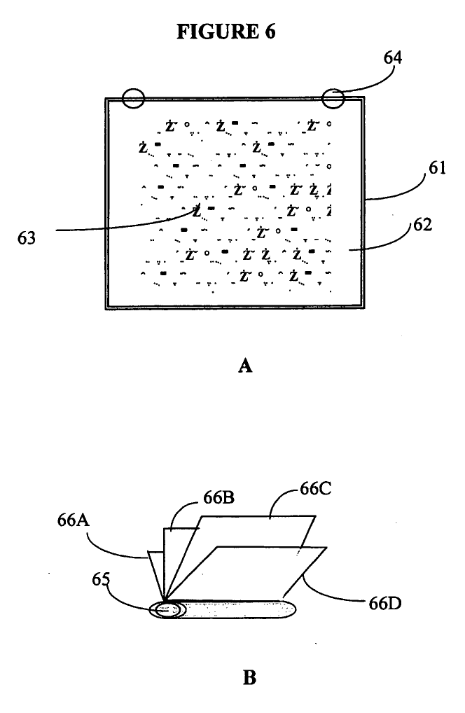

Reference is now made to FIG. 6A schematically presenting a device adapted to project cantillation marks or any other signs as defined in the present invention, said device comprises of a relatively rigid frame (61) accommodating a transparent sheet (62) whereat said cantillation and/or signs are written or printed (63). According to one embodiments of the present invention, anchoring devices are appended to said frame so that device is suitable to be appended upon the printed matter at any position. Said embodiment is especially useful to be used in that torah scroll that is to be open to be read in a perpendicular orientation.

Reference is still made to FIG. 6B schematically presenting a pager having note-pad characteristics. In this embodiment of the present invention, a plurality of transparent sheets (66A-D) are clasped or held in one of their rims by a mutual holder (65). Each of said sheets contains signs or cantillation to be projected over a subsequent page of the printed matter and/or torah scroll.

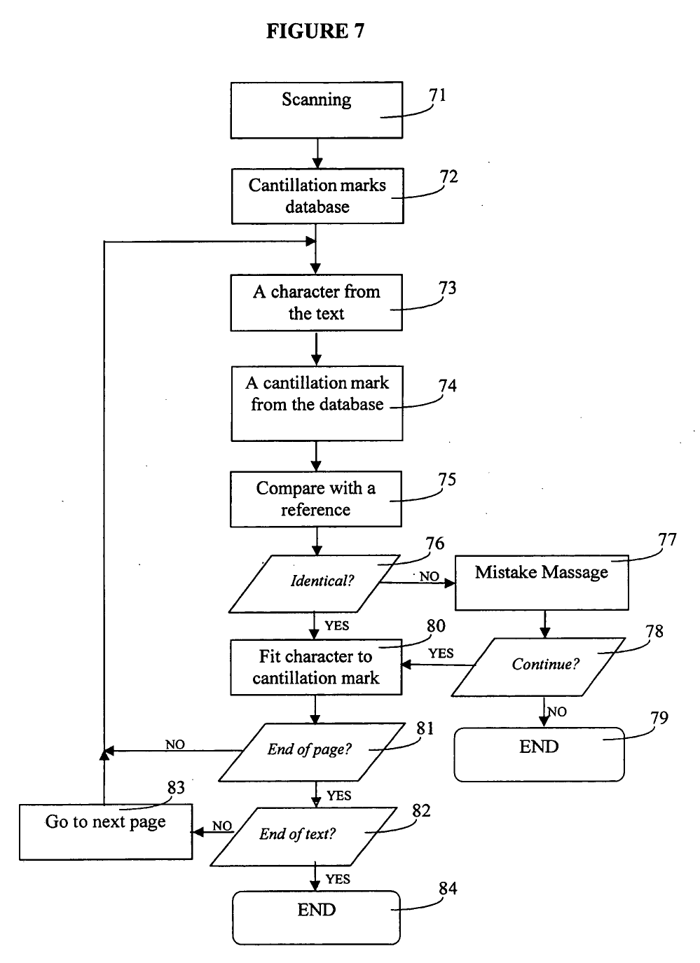

Reference is lastly made to FIG. 7 schematically presenting a simplified block diagram of the method for projecting signs, as such as cantillation marks on top of a printed matter, as such as a traditional handmade biblical scroll. Said printed matter may be already scanned or it is scanned (71) to a file. It is acknowledged that in many cases, expensive biblical scrolls are scanned in order to identify them in case of theft and additionally or alternatively, said scrolls are scanned to detect mistakes in the written text. Subsequently or in parallel, said cantillation marks of the original text is restored in a cantillation database (72). A character, a word or any suitable phrase of the original text (73) and a cantillation mark or a plurality of such marks (74) correlated to said characters are provided and subsequently compared (75) with a reference file comprising a character and its conjugated mark. The identity of the couple is now tested (76). In case the mark is not fitting the character, a mistake announcement is to be presented (77). If the user is allowing the correlation, the very same overlapping is provided (78). If the user does not allow the correlation, the process is stopped (79). The character is to be fitted with the cantillation mark or with any other sign as defined above (80). At the end of the page (81) of the original text the loop is continue until the end of the text (82) or the next page is been processed (83).

It is further in the scope of the present invention wherein the aforementioned scanning step (71) may be verified by other know techniques, such as photocopying the printed matter by any suitable means and processing said text by an OCR program so a text file is obtained, and so that X-Y coordination of the characters are registered for calculating the positioning of the signs for preparing a media for projection.

According to another preferred embodiment, the method for computerized projection of signs on a printed matter comprising; (a) scanning a sheet printed with characters each of which is having a predetermined X-Y coordination defining its location on the sheet ; (b) recognizing the characters by means of appropriate computer program; (c) registering the X-Y coordination of each character or of predetermined groups of characters; (d) matching appropriate sign or signs for each character (or group of characters); (e) determining for each sign or for each group of signs appropriate X-Y coordination respective to the corresponding character (or characters) (f) preparing a media of signs for projection on a corresponding sheet of printed characters.

According to one preferred embodiment of the present invention the matching of appropriate signs to corresponding characters is made by a computer algorithm which calculates what sign is appropriate to the recognized character or to the group of recognized characters (the algorithm may use arbitrary rules, such as “match the sign ‘%’ if the character is a number”). According to another preferred embodiment, the matching of appropriate signs to corresponding characters is made by a computer algorithm which verifies each character versus similar character existing in a predetermined comparison file with which the scanned file is believed to be exactly correspond, wherein at least a part of the characters of the comparison file are linked to corresponding signs, and wherein upon verification of a character in the scanned file as matching a versus character in the comparison file, a sign that is linked to the character in the comparison file is being copied to a new file that contains signs to be projected, wherein the signs are coordinated in a predetermined manner respective to the X-Y coordination of a corresponding scanned character.

1. A method for projecting signs on top of a printed matter comprising;
a. providing said printed matter in a manner suitable for said projection;
b. preparing said signs in a suitable media in the manner so that said signs are aligned with said printed matter;
c. projecting said signs on top of said printed matter such that said signs are superimposed on the printed matter in a predetermined manner.

2. The method according to claim 1, wherein the printed matter is a traditional torah scroll written by hand and further wherein the projected signs are cantillation marks.

3. The method according to claim 1, wherein the signs are selected from cantillation marks, vowel marks, punctuation marks, and/or musical notes;

4. The method according to claim 1, wherein the signs are means for editing the printed matter to be more readable.

5. The method according to claim 1, wherein the signs are selected from page number, header and/or footer, symbols, graphical signs, references and links, proofreading signs, the last word of previous page, the first word of coming page and/or the queue for reading the torah.

6. The method according to claim 1, wherein the signs are selected from Braille notes, text printed in various languages, colors, sizes and fonts, pictures and/or drawn animations.

7. The method according to claim 1, wherein the suitable media is a visual signal to be electronically projected on said printed matter.

8. A method according to claim 1, wherein the suitable media is a visual signal stored as a slide and is projected on the printed matter by a slide projector.

9. A method according to claim 1,, wherein the suitable media is a visual signal stored on a computer-readable electronic data carrier.

10. A method according to claim 1, wherein the suitable media is a transparent sheet comprising said signs and wherein the projection of the signs of step (c) is achieved by placing in a superimposed manner the transparent sheet on the printed matter.

11. The method according to claim 1, for preparing the suitable medium to be projected on the printed matter, in a computerized manner, the method comprising the following steps:
a. scanning the printed matter such in a way the text is restored in a file;
b. obtaining a database comprising a list of signs to be incorporated into the said text;
c. retrieving a character or a plurality of characters from the said text file;
d. retrieving a sign or a plurality of signs from the said database;
e. creating a conjugated character-signal couple from each of said character and said each of said signs
f. comparing said conjugated character-sign couple with a reference character-sign couple;
g. fitting said conjugated couple such in the way that all the text is aligned with signs, optionally said fitting is by a feed-back loop;
h. presenting the printed text with the aligned signs.

12. The method according to claim 11, wherein the scanning step (a) is replaced by the steps comprising;
a. photocopying and or scanning the printed matter so a file comprising said copied or scanned text is obtained;
b. translating the said file text by means of an OCR program so a text file is obtained.

13. A transparent sheet member adapted to project cantillation marks and/or signs on top of a printed matter for use in the method defined in claim 1.

14. The transparent sheet member according to claim 13, wherein said sheet is a composition of a plurality of stripes, projecting said signs mostly the line of the text and not the spaces between lines.

15. The transparent sheet member according to claim 13, framed in a relatively rigid frame or envelope.

16. The transparent sheet member according to claim 13, additionally comprising an anchor for attaching said member to the printed matter.

17. A scrolling device having a note-pad means to scroll a transparent sheet member according to claim 13.

18. A scrolling device useful to coordinate the transparent sheet member according to claim 13 on the printed matter so signs are projected on top of the printed matter with coordination with the text; said device comprises a first roll and a second roll, wherein a long transparent sheet member is accommodate in between, and further wherein at least one of said rolls is having means to roll the sheet so each of the pages of the printed matter is fitting a known portion of the signs.

19. Method for computerized projection of signs on a printed matter comprising;
(a) scanning a sheet printed with characters each of which is having a predetermined X-Y coordination defining its location on the sheet; (b) recognizing the characters by means of appropriate computer program; (c) registering the X-Y coordination of each character or of predetermined groups of characters; (d) matching appropriate sign or signs for each character or goup of characters; (e) determining for each sign or for each group of signs appropriate X-Y coordination respective to the corresponding character or characters; (f) preparing a media of signs for projection on a corresponding sheet of printed characters.
